(19) United States
(12) Patent Application Publication
(10) Pub. No.: US 2019/0303344 A1
(43) Pub. Date: Oct. 3, 2019

(54) VIRTUAL CHANNELS FOR HARDWARE ACCELERATION

(71) Applicant: Intel Corporation, Santa Clara, CA (US)

(72) Inventors: Yang KONG, Shanghai (CN); Shih-Wei Roger CHIEN, Shanghai (CN); Linna SHUANG, Shanghai (CN)

(21) Appl. No.: 16/462,834

(22) PCT Filed: Dec. 23, 2016
(86) PCT No.: PCT/CN2016/111718

§ 371 Date: May 21, 2019

(51) Int. Cl. G06F 15/173; G06F 9/50

(52) U.S. Cl. CPC G06F 15/17318; G06F 9/5077

(57) ABSTRACT

Apparatuses, methods and storage media associated with providing hardware acceleration by mapping data requests from a plurality of virtual machines to a plurality of virtual channels is described herein. In embodiments, an apparatus may include a plurality of programmable circuit cells and logic programmed into the programmable circuit cells to receive, from a plurality of virtual machines running on a processor coupled to the apparatus, a plurality of data flows that respectively contain a plurality of data requests. The apparatus may further map the plurality of data flows to a plurality of instances of acceleration logic, and to independently manage responses to the plurality of data flows. Other embodiments may be disclosed herein.

### TECHNICAL FIELD

The present disclosure relates to the fields of computing and networking. More specifically, the present disclosure is related to hardware accelerators supporting central processing units (CPUs) running virtual machines. In particular, the present disclosure relates to mapping data flows from virtual machines to virtual channels to manage consistency for data requests independently on each virtual channel.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

CPUs and hardware accelerator platforms, for example the Intel Xeon™ and Field Programmable Gate Array (FPGA), provide multiple physical links as interfaces between the CPUs/FPGA and other devices, such as physical memory. These interfaces may have different characteristics. For example, Intel QuickPath Interconnect™ (QPI) and UltraPath Interconnect™ (UPI) is a data coherence interface and supports out-of-order transactions, while Peripheral Component Interconnect Express (PCIe) is a non-coherence interface and supports in-order transactions. Combining these interfaces together and presenting a consistent view for software programmer or accelerator designer has some challenges.

For example, in a network functions virtualization (NFV) scenario, a number of multiple virtual machines (VMs) may share the same hardware accelerator in a single server supported by a processor with one or multiple CPUs. Typically, when the accelerator performs operations and is ready to generate a result, the accelerator sends out the result data first and then updates a data field such as an index and/or flag. Subsequently, when the software receives an interrupt or performs a polling function, the index and/or flag is referenced to make sure the existence of result. To prevent a race condition, the accelerator makes sure the output data is globally visible in the system before the index or flag change.

With multiple links and a transaction order that is always in order, a legacy technique to provide data consistency is to implement a write-fence to provide such order. A write-fence operation may wait until all previous writes are visible by checking the write completion signals before allowing the execution of write operation after the write-fence operation. However, mixing different flows of requests, for example from different VMs, while using a single write-fence may cause a serious performance impact. One write-fence will stop all data transfer until all previous data transfer transaction are completed. As a result, unnecessary cycles may be spent waiting to commence a data request operation, even when data among different flows of data requests have no data dependency on each other.

### BRIEF DESCRIPTION OF THE DRAWINGS

Embodiments of the present disclosure may overcome such limitations. These embodiments and disclosed techniques will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a block diagram of a computing platform including virtual machines with various virtual channel flows containing data requests mapped to different instances of acceleration logic of a hardware accelerator, and responses are managed by a traffic management response monitor of the hardware accelerator, according to various embodiments.

FIG. 2 is a block diagram of a traffic management response monitor managing virtual channel flow data request responses, according to various embodiments.

FIG. 3 is a flow diagram illustrating a method for servicing a plurality of data requests among a plurality of virtual channel flows by a hardware accelerator, according to various embodiments.

FIG. 4 illustrates a storage medium having instructions for practicing methods described with references to FIG. 3, according to various embodiments.

### DETAILED DESCRIPTION

Apparatuses, methods and storage media associated with facilitating data consistency using a hardware accelerator are disclosed herein. In embodiments, an apparatus may provide hardware acceleration to computing and may include a plurality of programmable circuit cells with logic programmed into the programmable circuit cells to receive, from a plurality of virtual machines (VM) running on a processor coupled to the apparatus, over a plurality of data channel flows, a plurality of data requests, and to map the plurality of data channel flows to a plurality of instances of acceleration logic to independently manage the plurality of data channel flows with data requests.

Some embodiments may further facilitate data consistency on behalf of the multiple VMs. Responses to the data requests of the virtual channel flows may be managed by a traffic management response monitor, for example, by implementing write-fence operations limited to data requests associated with a particular virtual channel flow. By dynamically mapping the virtual channel flows and managing responses to the data requests, overall data request servicing and throughput may be increased by delaying write requests only if they depend on the completion of related write requests within the same virtual channel flow.

In addition, each virtual channel flow may be accommodated to different physical link characteristics, for example physical links to a memory 116, which may be accessed through the processor 102, or to other physical devices (not shown) via physical interconnects 130. In embodiments, these devices may have varying characteristics such as different memory access characteristics regarding bandwidth and/or latency. In embodiments, data requests within virtual channels may be dynamically mapped to one or more accelerator logic functions 132a-132c that may act on the individual data requests within each virtual channel.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (ASIC), a System on a Chip (SoC), a processor (shared, dedicated, or group) and/or memory (shared, dedicated, or group) that execute one or more software or firmware programs, a combinational logic circuit, a field programmable gate array (FPGA), and/or other suitable components that provide the described functionality.

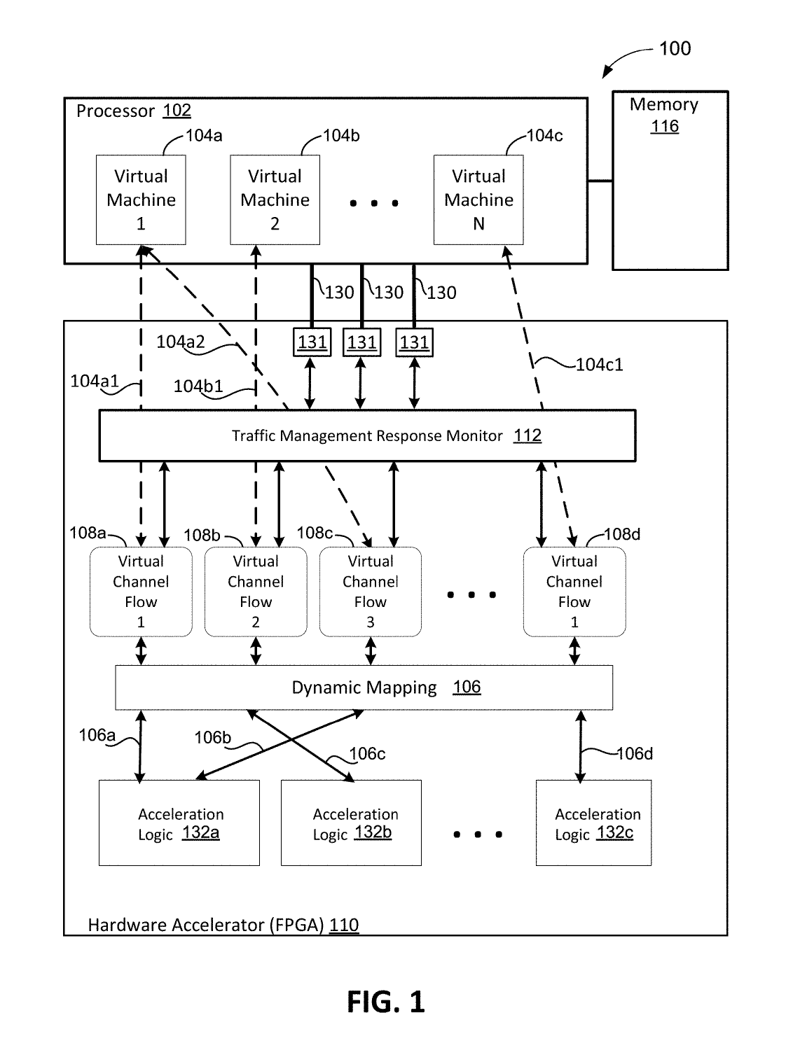

FIG. 1 is a block diagram of a computing platform including virtual machines with various virtual channel flows containing data requests mapped to a plurality of instances of acceleration logic of a hardware accelerator, and responses to the data requests are managed by a traffic management response monitor of the hardware accelerator, according to various embodiments. Diagram 100 shows a computing platform that may include a processor 102 (with one or more CPUs/cores) that may provide computer processing functionality for, for example, a computer server (not shown). In embodiments, processor 102 may support a plurality of virtual machines 104a, 104b, 104c that may provide one or more data requests 104a1, 104a2, 104b1, 104c1 destined for or results in access of a device. In embodiments, the data requests 104a1, 104a2, 104b1, 104c1 may be destined for or result in accesses of memory 116 coupled to processor 102 via interconnects 130. In embodiments, the one or more data requests 104a1, 104a2, 104b1, 104c1 may include or result in write requests to memory locations of memory 116, which may be shared and/or otherwise accessible to the plurality of virtual machines 104a, 104b, 104c. In embodiments, the plurality of virtual machines 104a, 104b, 104c may also be a plurality of virtual functions (such as virtualized network functions), or may be otherwise referred to as multiple tenants that are operating on processor 102 and/or hardware accelerator 110. In embodiments, as alluded to earlier, the processor 102 may have multiple processor cores (CPUs) operating in coordination or independently to operate the plurality of virtual machines 104a, 104b, 104c.

In embodiments, one or more data requests 104a1, 104a2, 104b1, 104c1 may be sent over one or more virtual channels, illustrated as virtual channel flows 108a-108d. In embodiments, these virtual channels may be implemented by processor 102, e.g., by a virtual machine 104a or a virtual machine manager (VMM) (not shown), or the hardware accelerator 110. In embodiments, the hardware accelerator 110 may be implemented with a FPGA. In alternate embodiments, the hardware accelerator 110 may be an Application Specific Integrated Circuit (ASIC).

In embodiments, the one or more virtual channel flows 108a-108d may have data requests within the virtual channel flows 108a-108d handled by various instances of acceleration logic 132a-132c. Further, responses to the data requests may be managed by the traffic management response monitor 112 for data consistency. This may result in the data consistency functions being handled independently for each virtual channel flow, resulting in overall improvement in performance for hardware accelerator 110. In embodiments where hardware accelerator 110 is implemented with a FPGA, the virtual channel flows 108a-108d may occupy physical memory and/or storage cells on the FPGA.

In embodiments, the data requests within each virtual channel flow 108a-108d may go through a dynamic mapping function 106. The dynamic mapping function 106 may create mappings 106a-106d to route data requests within the respective virtual channel data request flow to various instances of acceleration logic 132a-132c. In embodiments, the dynamic mapping function 106 may be configured to choose a mapping based upon one or more criteria. These criteria may include the availability of a virtual channel flow 108a-108d that is not in use, the bandwidth that a virtual channel flow 108a-108d may deliver, and/or other criteria. In embodiments, the dynamic mapping function 106 may request and/or receive additional information, such as address mapping for VM 104a-104c to virtual channel flows 108a-108d.

In embodiments, the acceleration logic 132a-132c may provide various functions within the accelerator 110. Once the dynamic mapping function 106 has selected a mapping 106a-106d, the acceleration logic 132a-132c may service the data requests in the virtual channel flows 108a-108d. Difference acceleration functions can co-exist inside hardware accelerator 110. For example, if hardware accelerator 110 is a crypto accelerator, it can contain digest/hash function, block cipher, and public/private key cipher. These functions can be selectively requested by the virtual machines 104a-104c based on their respective needs.

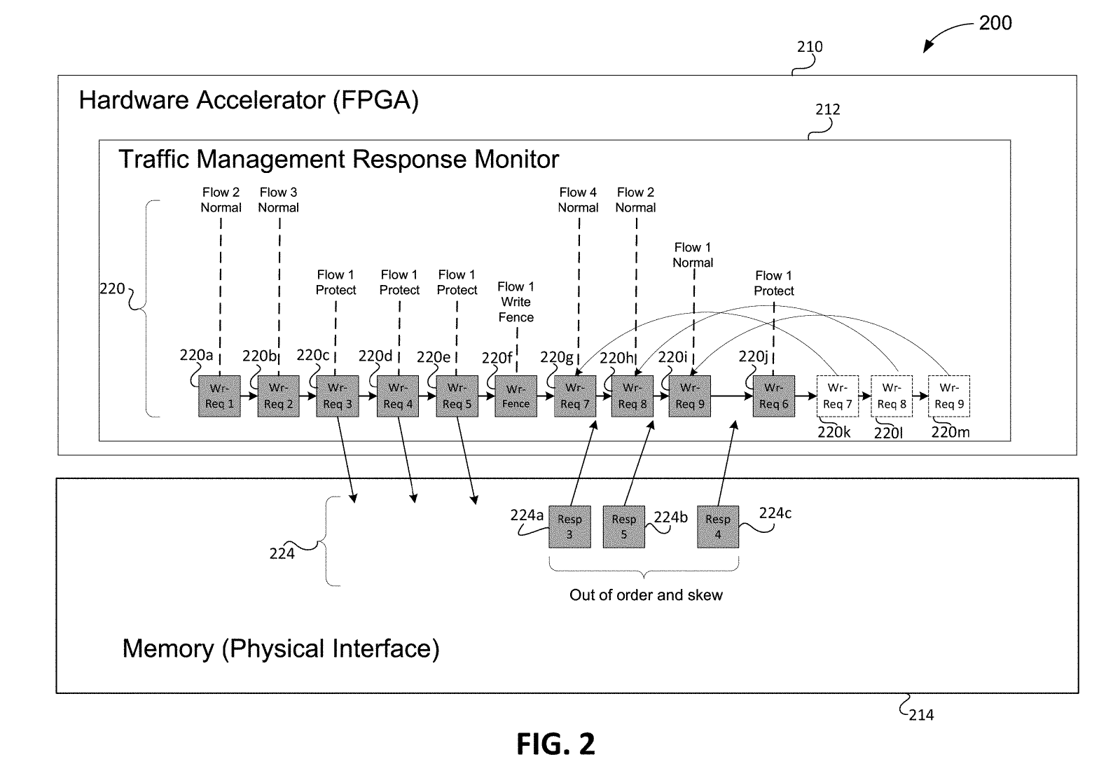

In embodiments, results of or responses to the data requests of virtual channel flows 108a-108d, processed by the acceleration logic 132a-132c may flow into the traffic management response monitor 112. In embodiments, the traffic management response monitor 112 disposed in hardware accelerator 110, described further in FIG. 2, may receive responses to data requests related to virtual channel flows 108a-108d and may manage forwarding the responses to other devices through interface controllers 131 that interface with physical interconnects 130.

In embodiments, the traffic management response monitor 112 may be configured to independently manage the data consistency of the responses of the various virtual channel flows 108a-108d, thereby improving the overall throughput of the acceleration. For example, the processing of individual data requests by the acceleration logic 132a-132c may include sending write requests to memory 116 via interconnect 130. Traffic management response monitor 112 may delay a write request of a virtual channel flow until other dependent write requests for the same virtual channel flow have been acknowledged by the memory 116. In embodiments, this may be referred to as virtual channel slicing, and may have the benefit of reducing wasted cycles and increasing data request throughput and link utilization. Increased link utilization may result from data requests in a dynamically mapped data flow within one virtual channel 108a, not blocking data requests within a different virtual channel 108b.

In embodiments, traffic management response monitor 112 may accommodate different physical link characteristics for devices served by the hardware accelerator 110, for bandwidth, latency and cache coherence. In embodiments, physical interconnects 130, which may include support for QPI and PCIe interfaces, supported by interface controllers 131, which may be used to communicate with devices outside the accelerator 110, may be supported by traffic management response monitor 112. In non-limiting examples, a Xeon™ with a hardware accelerator 110 platform, multiple PCIe and QPI/UPI interconnections 130 may be used.

FIG. 2 is a block diagram of a traffic management response monitor managing virtual channel data request flows, according to various embodiments. Diagram 200 shows a hardware accelerator 210, which may be similar to the hardware accelerator 110 of FIG. 1. In embodiments, the traffic management response monitor 212, which may be similar to the traffic management response monitor 112, may be implemented within hardware accelerator 210.

An example data request flow sequence 220 may show how data requests such as write requests from virtual channel data request flows such as virtual channel flows 108a-108d may be managed. The two terms virtual channel data request flows and virtual channel flows may be considered synonymous. Data requests within the flow management sequence 220 may be associated with a flow identifier of the virtual channel flow to which the data request has been mapped. Data requests may also be associated with a data type which, in embodiments, may be of two types: “normal” and “protect.” In embodiments, normal may be referred to as “unprotect.” In addition, a data request may be associated with a function, such as a read request, a write request, a write-fence request, or some other request. In embodiments, the data type of protect or normal may be associated with write requests. In embodiments, the traffic management response monitor 212 may use the flow identifier, for example for write requests and write-fence requests, to implement virtual channel flow-dependent request write-fence blocking in the hardware accelerator 210 for a particular flow identifier.

In the example of FIG. 2, the numbers of the write requests shown, for example Wr-Req 1 220a, Wr-Req 2 220b, Wr-Req3 220c, Wr-Req 4 220d, Wr-Req 5 220e, Wr-Req 6 220j, Wr-Req 7 220g, Wr-Req 8 220h, and Wr-Req 9 220i may represent the order in which the traffic management response monitor 212 received the data requests from the virtual channel data request flows 108a-108d of FIG. 1 from virtual machines 104a, 104b, 104c. The positions of the write requests 220a-220j from left to right may represent the order in which the data request was sent to the physical memory 216. The flow number identifier, for example 1-4, may be a virtual channel flow number associated with each write request.

In embodiments, for a normal (unprotect) write request 220a, 220b, 220g, 220h, 220i, the write request may not require an acknowledgment to be received by the physical memory 216 before another normal write request from the same virtual channel data request flow, or other virtual channel data request flow, is sent to the memory 216. This may be due to a lack of dependency between the individual write requests.

In contrast, protect write requests for a particular virtual channel data request flow, such as Wr-Req 3 220c, Wr-Req 4 220d, and Wr-Req 5 220e on virtual channel data request flow 1, may be sent to the traffic management response monitor 212. A Wr-Fence 220f write-fence data request may be received by the traffic management response monitor 212 for flow 1 to indicate that all write-protect requests should be acknowledged by the memory 216 before any further write-protect requests are processed.

This write-fence request 220f may cause the traffic management response monitor 212 to delay sending any further protect write data requests for virtual channel data request flow 1 until a response has been received for each protect write prior to the Wr-Fence 220f request for virtual channel data request flow 1. In this example, protect write request Wr-Req 6 220j may be delayed until the responses for all pending protect write requests have been received, for example responses Resp 3 224a associated with Wr-Req 3 220c, Resp5 224b associated with Wr-Req5 220e, and Resp 4 224c associated with Wr-Req 4 220d. These responses may indicate that the protect write requests have been successfully written to the memory 216. It should be noted that the responses may be received in an order that is different than the original write protect requests. This may be important, for example, when there is dependency on a memory access location that is to be updated to make sure that a subsequent read from that memory access location retrieves the correct (latest) data from the memory.

In this way, a protect write request for a virtual channel flow may only block protect write requests of that virtual channel data request flow and not block protect write requests of any other virtual channel data request flows. As a result, idle time in queue processing by the traffic management response monitor 212 may be greatly reduced by restricting data dependency coordination to data requests within a particular virtual channel data request flow.

Advantages of embodiments similar to the example described above may include a higher overall throughput of write requests to the memory 224 in comparison to legacy systems that do not map virtual machine 104a, 104b, 104c data requests into virtual channels data requests 108a-108d. In such legacy systems, a single write-fence may block all transactions from all virtual machines to a physical channel, for example prevent all data writes from being sent to a memory 224 until an acknowledgment has been received from each write. In addition, in legacy implementations multiple virtual machines may block each other when multiple write-fences are performed.

However, in embodiments, by dynamically mapping data requests from each virtual machine 104 to a separate virtual channel flow and implementing a write-fence request for a particular virtual channel data request flow, useless data consistency dependencies may be eliminated and throughput maximized between the processor 102 and the hardware accelerator 210. In embodiments, the process implemented by the traffic management response monitor 212 of the hardware accelerator 210 may be referred to as “slicing” on the physical channel to avoid blocking and undo delays resulting from blocked data requests that do not need to be blocked to avoid data inconsistency.

As a result, in legacy implementations, write requests that may have been blocked 220k, 2201, 220m until after all acknowledgments 224 have been received may now, in embodiments, be moved earlier in the queue 220g, 220h, 220i based on their virtual channel data requests flow identification, and may be based on the data request's status of normal versus protect.

In embodiments, a physical interface catalog and number may also be used to support various physical interfaces. This may include data coherency interfaces for various devices (not shown) that may use physical interconnects 130, such as QuickPath Interconnect (QPI), as well as non-coherency interfaces such as Peripheral Component Interconnect Express (PCIe). In addition, in embodiments, other types of data requests may be implemented by this process.

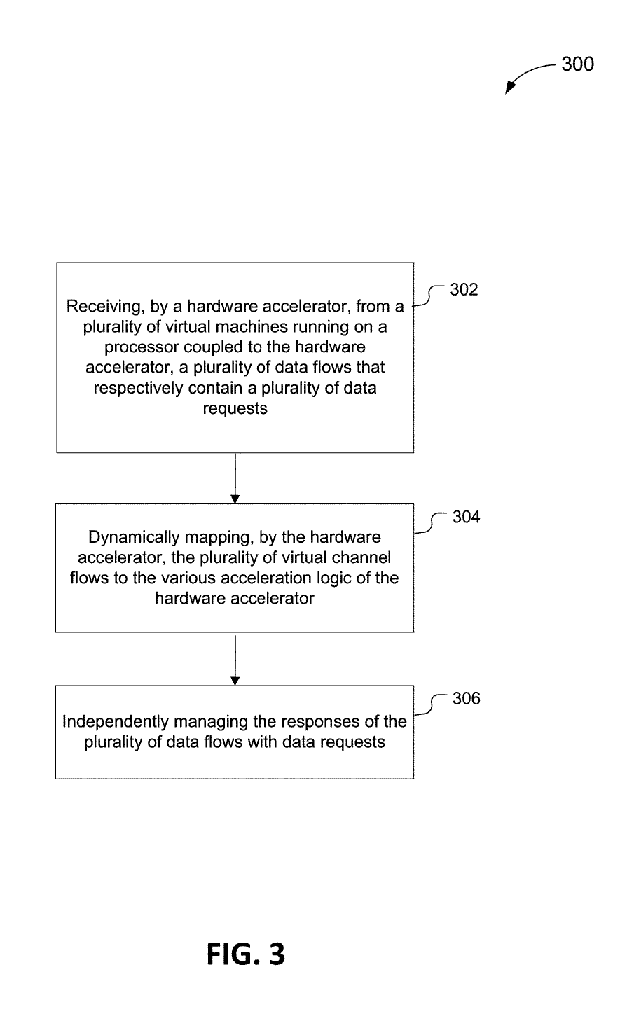

FIG. 3 is a flow diagram illustrating a method for servicing a plurality of data requests among a plurality of virtual channels by a hardware accelerator, according to various embodiments. The process flow 300 may, in embodiments, be practiced by the dynamic mapping function 106 and/or the traffic management response monitor 112 of the hardware accelerator 110 of FIG. 1. In embodiments, the dynamic mapping function 106 may receive data requests of various virtual channel flows destined for one of acceleration logic 132a-132c, that are generated by virtual machines 104a, 104b, 104c running on processor 102. These generated data requests of a plurality of virtual channel flows 108a-108d may be mapped to selected ones of acceleration logic 132a. On servicing the data requests by acceleration logic 132a, the traffic management response monitor 112 may then independently manage responses of each virtual channel flow 108a-108d to ensure data consistency, e.g., for writes sent to the memory 116 within each respective virtual channel flow.

At block 302, the process may include receiving, by a hardware accelerator, from a plurality of virtual machines running on a processor coupled to the hardware accelerator, a plurality of data flows that respectively contain a plurality of data requests. In embodiments, the virtual machines 104a, 104b, 104c may produce a plurality of data requests 104a1, 104a2, 104b1, 104c1 that may be received by the hardware accelerator 110. In embodiments, these data requests may be sent to a hardware accelerator over one or more virtual channel flows 108a-108d. In embodiments, the hardware accelerator may be implemented as a FPGA that contains a plurality of programmable circuit cells where logic to implement one or more of the methods disclosed herein may be programmed into the plurality of programmable circuit cells.

At block 304, the process may include dynamically mapping, by the hardware accelerator, the plurality of virtual channel flows to the various acceleration logic of the hardware accelerator. In embodiments, this may be performed by the dynamic mapping function 106, which may be part of the hardware accelerator 110. These acceleration logic functions may provide additional processing of the data requests within the virtual channel flows 108a-108d, as described above, e.g., different crypto services as desired by the virtual machines, as described above. The results or response of the various virtual channel flows 108a-108d may then be sent to the traffic management response monitor 112.

At block 306, the process may include independently managing the responses of the plurality of data flows with data requests. In embodiments, this may be performed by the traffic management response monitor 212 that may handle the responses to data requests within one virtual channel data request flow independently of another virtual channel data request flow. In embodiments, the responses to data requests 220a-220j may include write requests for data to be written into a device such as a physical memory 216. In embodiments, as discussed above, the response of a data request may be associated with particular virtual channel data request flow. Responses to data requests 220a-220j may include a data flow identifier, which may be a virtual channel flow identifier may include a function, and may include a data type. The function may include one of read, write, and write-fence. The data type may include protected or unprotected. The unprotected data type may also be referred to as normal. In embodiments, a write-fence request may cause a protected write request to not be sent to physical memory 216 until an acknowledgment is received from the memory 216 for each write protect request prior to the write-fence request.

In embodiments, the traffic management response monitor 212 with respect to a virtual channel data request flow may be in write-fence mode when a data request of the data flow includes a write-fence function to protect one or more data requests of the data flow with write function.

In embodiments, the traffic management response monitor 212 with respect to a virtual channel data request flow may identify a data flow as not in write-fence mode if a response has been received for each protected data write request a data flow sent to the memory 216.

In embodiments, the traffic management response monitor 212 with respect to a virtual channel data request flow may send a data request of a data flow to the device, if the data flow is not in write-fence mode and the data request is not protected.

In embodiments, the traffic management response monitor 212 with respect to a virtual channel data request flow may delay sending a protected data request of a data flow that is in write-fence mode.

In embodiments, the traffic management response monitor 112 may communicate data requests with other devices (not shown) via one or more physical interconnects 130 that may be associated with each device.

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, executable instructions, etc.) or an embodiment combining software and hardware aspects that may all generally be referred to as a “module” or “system.” Furthermore, the present disclosure may take the form of a computer program product embodied in any tangible or non-transitory medium of expression having computer-usable program code embodied in the medium.

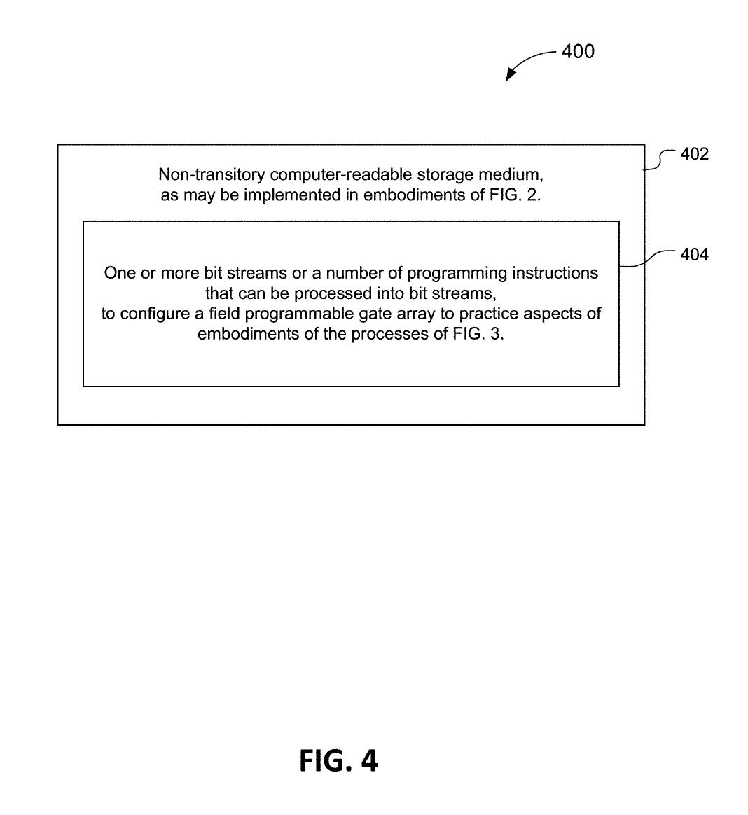

FIG. 4 illustrates an example computer-readable non-transitory storage medium that may be suitable for use to store bit streams to configure a hardware accelerator, to practice selected aspects of the present disclosure. As shown, non-transitory computer-readable storage medium 402 may include one or more bit streams or a number of programming instructions 404 that can be processed into bit streams. Bit streams/programming instructions 404 may be used to configure a device, e.g., hardware accelerator 110, with logic to perform operations associated with the traffic management response monitor 112 and/or the dynamic mapping function 106. In alternate embodiments, bit streams/programming instructions 404 may be disposed on multiple computer-readable non-transitory storage media 402 instead. In alternate embodiments, bit streams/programming instructions 404 may be disposed on computer-readable transitory storage media 402, such as signals.

In embodiments, the bit streams/programming instructions 404 may be configured into a hardware accelerator 110 that is implemented as an FPGA. In these embodiments, the processes disclosed herein may be represented as logic that is programmed into the programmable circuit cells of the FPGA.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, may be used to implement the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instructions which implement the function/act specified in the flowchart and/or block diagram block or blocks.

The computer program instructions may also be loaded onto a computer or other programmable data processing apparatus to cause a series of operations to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, acts, operations, elements, and/or components, but do not preclude the presence or addition of one or more other features, integers, acts, operation, elements, components, and/or groups thereof.

Embodiments may be implemented as a computer process, a computing system or as an article of manufacture such as a computer program product of computer readable media. The computer program product may be a computer storage medium readable by a computer system and encoding a computer program instructions for executing a computer process.

The corresponding structures, material, acts, and equivalents of all means or steps plus function elements in the claims below are intended to include any structure, material or act for performing the function in combination with other claimed elements are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment was chosen and described in order to best explain the principles of the disclosure and the practical application, and to enable others of ordinary skill in the art to understand the disclosure for embodiments with various modifications as are suited to the particular use contemplated.

Thus various example embodiments of the present disclosure have been described including, but are not limited to:

Example 1 may be an apparatus for providing hardware acceleration to computing, comprising: a plurality of programmable circuit cells; and logic programmed into the programmable circuit cells to: receive, from a plurality of virtual machines running on a processor coupled to the apparatus, a plurality of data flows that respectively contain a plurality of data requests; map the plurality of data flows to a plurality of instances of acceleration logic; and manage responses to the plurality of data flows independent of one another.

Example 2 may include the apparatus of example 1, wherein a data request comprises a data flow identifier, a function, and a data type, wherein the function further includes one of read, write, and write-fence, and wherein the data type includes one of protected or unprotected.

Example 3 may include the apparatus of one of examples 1-2, wherein to manage the responses to the plurality of data flows independent of one another comprises: to identify a data flow as in a write-fence mode when a data request of the data flow includes a write-fence function to protect one or more data requests of the data flow with write function.

Example 4 may include the apparatus of one of examples 1-2, wherein to manage the responses to the plurality of data flows independent of one another comprises: to identify a first data flow as not in write-fence mode, if a response has been received by the apparatus from the device for each protected data write request a data flow sent to the device.

Example 5 may include the apparatus of one of examples 1-2, wherein to manage the responses to the plurality of data flows independent of one another comprises: to send a data request of a data flow to the device, if the data flow is not in write-fence mode and the data request is not protected.

Example 6 may include the apparatus of one of examples 1-2, wherein to manage the responses to the plurality of data flows independent of one another comprises: to delay sending a protected data request of a data flow in write-fence mode.

Example 7 may include the apparatus of one of examples 1-2, wherein the data requests are instructions to one or more devices.

Example 8 may include the apparatus of example 7, wherein the device is a memory device.

Example 9 may include the apparatus of one of examples 1-2, wherein the apparatus is a field programmable gate array (FPGA), and the programmable circuit cells are programmable gates of the FPGA.

Example 10 may be a computing system, comprising: a processor to run a plurality of virtual machines; a device coupled to the processor; an accelerator coupled to the processor and to the device, the accelerator to: receive, from a plurality of virtual machines running on the processor coupled to the apparatus, a plurality of data flows that respectively contain a plurality of data requests; map the plurality of data flows to a plurality of instances of acceleration logic; and manage responses to the plurality of data flows independent of one another.

Example 11 may include the computing system of example 10, wherein a data request comprises a data flow identifier, a function, and a data type, wherein the function further includes one of read, write, and write-fence, and wherein the data type includes one of protected or unprotected.

Example 12 may include the computing system of any one of examples 10-11, wherein to manage the responses to the plurality of data flows independent of one another comprises: to identify a data flow as in a write-fence mode when a data request of the data flow includes a write-fence function to protect one or more data requests of the data flow with write function.

Example 13 may include the computing system of any one of examples 10-11, wherein to manage the responses to the plurality of data flows independent of one another comprises: to identify a first data flow as not in write-fence mode, if a response has been received by the apparatus from the device for each protected data write request a data flow sent to the device.

Example 14 may include the computing system of any one of examples 10-11, wherein to manage the responses to the plurality of data flows independent of one another comprises: to send a data request of a data flow to the device, if the data flow is not in write-fence mode and the data request is not protected.

Example 15 may include the computing system of any one of examples 10-11, wherein to manage the responses to the plurality of data flows independent of one another comprises: to delay sending a protected data request of a data flow in write-fence mode.

Example 16 may be a method for providing hardware acceleration to computing, comprising: receiving, by a hardware accelerator, from a plurality of virtual machines running on a processor coupled to the hardware accelerator, a plurality of data flows that respectively contain a plurality of data requests; mapping, by the hardware accelerator, the plurality of data flows to a plurality of instances of acceleration logic; and managing responses to the plurality of data flows independent of one another.

Example 17 may include the method of example 16, wherein a data request comprises a data flow identifier, a function, and a data type, wherein the function further includes one of read, write, and write-fence, and wherein the data type includes one of protected or unprotected.

Example 18 may include the method of any one of examples 16-17, wherein to managing the responses to the plurality of data flows independent of one another comprises: identifying a data flow as in a write-fence mode when a data request of the data flow includes a write-fence function to protect one or more data requests of the data flow with write function.

Example 19 may include the method of any one of examples 16-17, wherein managing the responses to the plurality of data flows independent of one another comprises: identifying a first data flow as not in write-fence mode, if a response has been received by the apparatus from the device for each protected data write request a data flow sent to the device.

Example 20 may include the method of any one of examples 16-17, wherein managing the responses to the plurality of data flows independent of one another comprises: sending a data request of a data flow to the device, if the data flow is not in write-fence mode and the data request is not protected.

Example 21 may include the method of any one of examples 16-17, wherein managing the responses to the plurality of data flows independent of one another comprises: to delay sending a protected data request of a data flow in write-fence mode.

Example 22 may include the method of any one of examples 16-17, wherein the device includes multiple devices.

Example 23 may include the method of any one of examples 16-17, wherein the device is a memory device.

Example 24 may include the method of any one of examples 1-2, wherein the hardware accelerator is a field programmable gate array (FPGA).

Example 25 may be a computer-readable media comprising a bit stream or programming instructions that can be processed into bit streams that cause a hardware accelerator, in response to receiving the bit stream, to be configured to: receive from a plurality of virtual machines running on a processor coupled to the hardware accelerator, a plurality of data flows that respectively contain a plurality of data requests; map the plurality of data flows to a plurality of instances of acceleration logic; and manage responses to the plurality of data flows independent of one another.

Example 26 may include the computer-readable media of example 25, wherein a data request comprises a data flow identifier, a function, and a data type, wherein the function further includes one of read, write, and write-fence, and wherein the data type includes one of protected or unprotected.

Example 27 may include the computer-readable media of any one of examples 25-26, wherein to manage the responses to the plurality of data flows independent of one another comprises: to identify a data flow as in a write-fence mode when a data request of the data flow includes a write-fence function to protect one or more data requests of the data flow with write function.

Example 28 may include the computer-readable media of any one of examples 25-26, wherein to manage the responses to the plurality of data flows independent of one another comprises: to identify a first data flow as not in write-fence mode, if a response has been received by the apparatus from the device for each protected data write request a data flow sent to the device.

Example 29 may include the computer-readable media of any one of examples 25-26, wherein to manage the responses to the plurality of data flows independent of one another comprises: to send a data request of a data flow to the device, if the data flow is not in write-fence mode and the data request is not protected.

Example 30 may be an apparatus for providing hardware acceleration to computing, comprising: means for receiving from a plurality of virtual machines running on a processor coupled to the hardware accelerator, a plurality of data flows that respectively contain a plurality of data; means for mapping the plurality of data flows to a plurality of instances of acceleration logic; and means for managing responses to the plurality of data flows independent of one another.

Example 31 may include the apparatus of example 30, wherein a data request comprises a data flow identifier, a function, and a data type, wherein the function further includes one of read, write, and write-fence, and wherein the data type includes one of protected or unprotected.

Example 32 may include the apparatus of any one of examples 30-31, wherein means for managing the plurality of data flows independent of one another comprises: means for identifying a data flow as in a write-fence mode when a data request of the data flow includes a write-fence function to protect one or more data requests of the data flow with write function.

Example 33 may include the apparatus of any one of examples 30-31, wherein means for managing the responses to the plurality of data flows independent of one another comprises: means for identifying a first data flow as not in write-fence mode, if a response has been received by the apparatus from the device for each protected data write request a data flow sent to the device.

Example 34 may include the apparatus of any one of examples 30-31, wherein means for managing the responses to the plurality of data flows independent of one another comprises: means for sending a data request of a data flow to the device, if the data flow is not in write-fence mode and the data request is not protected.

Example 35 may include the apparatus of any one of examples 30-31, wherein means for managing the responses to the plurality of data flows independent of one another comprises: means for delaying sending a protected data request of a data flow in write-fence mode.

Example 36 may include the apparatus of any one of examples 30-31, wherein the data requests are instructions to one or more devices.

Example 37 may include the apparatus of example 36, wherein the device is a memory device.

Example 38 may include the apparatus of any one of examples 30-31, wherein the hardware accelerator is a field programmable gate array (FPGA).

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. An apparatus for providing hardware acceleration to computing, comprising:
a plurality of programmable circuit cells; and
logic programmed into the programmable circuit cells to:
receive, from a plurality of virtual machines running on a processor coupled to the apparatus, a plurality of data flows that respectively contain a plurality of data requests;
map the plurality of data flows to a plurality of instances of acceleration logic; and
manage responses to the plurality of data flows independent of one another.

2. The apparatus of claim 1, wherein a data request comprises a data flow identifier, a function, and a data type, wherein the function further includes one of read, write, and write-fence, and wherein the data type includes one of protected or unprotected.

3. The apparatus of claim 1, wherein to manage the responses to the plurality of data flows independent of one another comprises:
to identify a data flow as in a write-fence mode when a data request of the data flow includes a write-fence function to protect one or more data requests of the data flow with write function.

4. The apparatus of claim 1, wherein to manage the responses to the plurality of data flows independent of one another comprises:
to identify a first data flow as not in write-fence mode, if a response has been received by the apparatus from the device for each protected data write request a data flow sent to the device.

5. The apparatus of claim 1, wherein to manage the responses to the plurality of data flows independent of one another comprises:
to send a data request of a data flow to the device, if the data flow is not in write-fence mode and the data request is not protected.

6. The apparatus of claim 1, wherein to manage the responses to the plurality of data flows independent of one another comprises:
to delay sending a protected data request of a data flow in write-fence mode.

7. The apparatus of claim 1, wherein the data requests are instructions to one or more devices.

8. The apparatus of claim 7, wherein the device is a memory device.

9. The apparatus of claim 1, wherein the apparatus is a field programmable gate array (FPGA), and the programmable circuit cells are programmable gates of the FPGA.

10. A computing system, comprising:
a processor to run a plurality of virtual machines;
a device coupled to the processor;
an accelerator coupled to the processor and to the device, the accelerator to:
receive, from a plurality of virtual machines running on the processor coupled to the apparatus, a plurality of data flows that respectively contain a plurality of data requests;
map the plurality of data flows to a plurality of instances of acceleration logic; and
manage responses to the plurality of data flows independent of one another.

11. The computing system of claim 10, wherein a data request comprises a data flow identifier, a function, and a data type, wherein the function further includes one of read, write, and write-fence, and wherein the data type includes one of protected or unprotected.

12. The computing system of claim 10, wherein to manage the responses to the plurality of data flows independent of one another comprises:
to identify a data flow as in a write-fence mode when a data request of the data flow includes a write-fence function to protect one or more data requests of the data flow with write function.

13. The computing system of claim 10, wherein to manage the responses to the plurality of data flows independent of one another comprises:
to identify a first data flow as not in write-fence mode, if a response has been received by the apparatus from the device for each protected data write request a data flow sent to the device.

14. The computing system of claim 10, wherein to manage the responses to the plurality of data flows independent of one another comprises:
to send a data request of a data flow to the device, if the data flow is not in write-fence mode and the data request is not protected.

15. The computing system of claim 10, wherein to manage the responses to the plurality of data flows independent of one another comprises:
to delay sending a protected data request of a data flow in write-fence mode.

16. A method for providing hardware acceleration to computing, comprising:
receiving, by a hardware accelerator, from a plurality of virtual machines running on a processor coupled to the hardware accelerator, a plurality of data flows that respectively contain a plurality of data requests;
mapping, by the hardware accelerator, the plurality of data flows to a plurality of instances of acceleration logic; and
managing responses to the plurality of data flows independent of one another.

17. The method of claim 16, wherein a data request comprises a data flow identifier, a function, and a data type, wherein the function further includes one of read, write, and write-fence, and wherein the data type includes one of protected or unprotected.

18. The method of claim 16, wherein to manage the responses to the plurality of data flows independent of one another comprises:
identifying a data flow as in a write-fence mode when a data request of the data flow includes a write-fence function to protect one or more data requests of the data flow with write function.

19. The method of claim 16, wherein managing the responses to the plurality of data flows independent of one another comprises:
identifying a first data flow as not in write-fence mode, if a response has been received by the apparatus from the device for each protected data write request a data flow sent to the device.

20. An apparatus for providing hardware acceleration to computing, comprising:
means for receiving from a plurality of virtual machines running on a processor coupled to the hardware accelerator, a plurality of data flows that respectively contain a plurality of data;
means for mapping the plurality of data flows to a plurality of instances of acceleration logic; and
means for managing responses to the plurality of data flows independent of one another.

21. The apparatus of claim 20, wherein a data request comprises a data flow identifier, a function, and a data type, wherein the function further includes one of read, write, and write-fence, and wherein the data type includes one of protected or unprotected.

22. The apparatus of claim 20, wherein means for managing the plurality of data flows independent of one another comprises:
means for identifying a data flow as in a write-fence mode when a data request of the data flow includes a write-fence function to protect one or more data requests of the data flow with write function.

23. The apparatus of claim 20, wherein means for managing the responses to the plurality of data flows independent of one another comprises:
means for identifying a first data flow as not in write-fence mode, if a response has been received by the apparatus from the device for each protected data write request a data flow sent to the device.

24. The apparatus of claim 20, wherein means for managing the responses to the plurality of data flows independent of one another comprises:
means for sending a data request of a data flow to the device, if the data flow is not in write-fence mode and the data request is not protected.

25. The apparatus of claim 20, wherein means for managing the responses to the plurality of data flows independent of one another comprises:
means for delaying sending a protected data request of a data flow in write-fence mode.
